(19) United States
(12) Patent Application Publication
(10) Pub. No.: US 2018/0038696 A1
(43) Pub. Date: Feb. 8, 2018

(54) A SYSTEM FOR USE IN A VEHICLE

(71) Applicant: Jaguar Land Rover Limited, Coventry, Warwickshire (GB)

(72) Inventor: Andrew FAIRGRIEVE, Coventry, Warwickshire (GB)

(21) Appl. No.: 15/554,404

(22) PCT Filed: Mar. 3, 2016
(86) PCT No.: PCT/EP2016/054580

§ 371 Date: Aug. 29, 2017

(30) Foreign Application Priority Data
Mar. 5, 2015 (GB) 1503715.3

(51) Int. Cl. G01C 21/20; G08G 1/01; G07C 5/08

(52) U.S. Cl. CPC G01C 21/20; G07C 5/085; G08G 1/0112; G08G 1/0129

(57) ABSTRACT

The present invention relates to a system for use in a vehicle for determining in real time whether to permanently store vehicle data indicative of at least one vehicle-related feature during a vehicle journey. The system includes receiving means configured to receive the vehicle data from at least one subsystem of the vehicle, and means configured to permanently store the vehicle data indicative of the at least one vehicle-related feature at a first location of the vehicle journey as a permanent data point. In addition, there includes means configured to temporarily store the vehicle data indicative of the at least one vehicle-related feature at a second location of the vehicle journey as a temporary data point, the second location being subsequent to the first location. Further, the system includes determination means operable during the vehicle journey to determine an equation of the straight line passing through the permanent data point and a current data point indicative of the at least one vehicle-related feature at substantially a current location of the vehicle, and to determine a shortest distance between the temporary data point and the determined straight line. The determination means is configured to permanently store the temporary data point as a permanent data point only if the calculated shortest distance is greater than a predetermined threshold distance value.

### TECHNICAL FIELD

The present disclosure relates to a system for use in a vehicle and particularly, but not exclusively to a system that enables the vehicle to determine in real time whether to permanently store vehicle data indicative of at least one vehicle-related feature during a vehicle journey. Aspects of the invention relate to a vehicle system, to a method, and to a vehicle.

### BACKGROUND

There is interest in a vehicle being capable of storing a route that has been travelled, particularly when the vehicle is travelling along an unknown route. This may be used, for example, during subsequent journeys to help traverse the same route, or to determine whether an optimal path was taken. Such a system is also of use in other areas such as hillwalking and skiing.

Current systems use the well-known Douglas Peucker method which is a means to reduce the number of data points that are needed to approximate a shape to within a prescribed accuracy to the minimum necessary.

During a vehicle journey, positional data (for example, including information relating to the geographical location of the vehicle) in the form of data points is stored by the vehicle at regular intervals along a route travelled by the vehicle. At the end of the journey the Douglas Peucker method uses the stored data points to approximate the route travelled, whilst also discarding any data points that are not necessary to achieve the level of accuracy needed for the approximation. In particular, this method firstly involves determining whether the distance between the straight line passing through the first data point (for example, the journey start position) and the last data point (for example, the journey end position) and the intermediate data point which is farthest from this straight line is greater or less than a threshold.

If the distance is less than the threshold then this data point is not stored to approximate the route, and the route is simply approximated as the straight line between the first and last data points.

If the distance is greater than the threshold then this data point is stored as an intermediate data point and used to approximate the route. In this case the process is repeated for the straight lines passing through the first data point and the intermediate data point, and for the intermediate data point and the last data point. It is determined whether the intermediate data points that are farthest from each of these straight lines are stored for approximating the route or not in the same manner as described above. The process is repeated until all of the intermediate data points have been stored for use in approximating the route or discarded.

At each step, the distance from each intermediate data point to a particular straight line needs to be determined, which may be computationally expensive.

The above-described method is defined for post processing which means that all of the data points along a route need to be stored until the end of the vehicle journey, which leads to relatively large memory requirements.

Current systems store temporary data points relatively infrequently, in particular typically every 200 metres. When the vehicle is travelling in substantially a straight line then this is an inefficient use of memory; however, when the vehicle is traversing a more complex route then this may not capture all of the details of the route which may result in a driver who is following such a route to take an incorrect path.

One aim of the present invention is to provide a vehicle control system that is configured to store an unknown route that is traversed by a vehicle, that addresses the difficulties described above in such a way that the systems in the prior art cannot.

### SUMMARY OF THE INVENTION

Aspects and embodiments of the invention provide a system, a method and a vehicle as claimed in the appended claims.

According to an aspect of the invention, there is provided a system for use in a vehicle for determining in real time whether to permanently store vehicle data indicative of at least one vehicle-related feature during a vehicle journey. The system may comprise means configured to receive the vehicle data in real time from at least one subsystem of the vehicle. The system may comprise means configured to permanently store the vehicle data indicative of the at least one vehicle-related feature at a first location of the vehicle journey as a permanent data point. The system may comprise means configured to temporarily store the vehicle data indicative of the at least one vehicle-related feature at a second location of the vehicle journey as a temporary data point, the second location being subsequent to the first location. The system may comprise determination means operable during the vehicle journey to determine an equation of the straight line passing through the permanent data point and a current data point indicative of the at least one vehicle-related feature at substantially a current location of the vehicle, and to determine a shortest distance between the temporary data point and the determined straight line. The determination means may be configured to permanently store the temporary data point as a permanent data point only if the calculated shortest distance is greater than a predetermined threshold distance value.

The disclosed system advantageously operates in real time which means that each temporary data point is analysed during the vehicle journey soon after it is received, rather than analysing all of the stored temporary data points at the end of the vehicle journey. This allows a greater number of temporary data points to be input and stored in the system during a vehicle journey without increasing the system's memory requirements. In other words, the temporary data points may be input to the system relatively frequently so that any relatively sudden changes to the at least one feature of the vehicle is captured, and permanently stored as a permanent data point. The above system makes use of three data points: a permanent data point, a temporary data point and a current data point. The temporary data point lies between the permanent data point and current data point.

The means configured to receive and to determine may comprise an electronic control unit or one or more controllers. For example, said means configured to receive vehicle data from at least one subsystem of the vehicle comprises an electronic processor having an electrical input for receiving an electronic signal from said at least one subsystem indicative of said vehicle data. The electronic controller, or the one or more controllers may have, associated therewith, micro-processors programmed to execute the required functions. For example, the system may comprise an electronic memory device electrically coupled to the electronic processor and having instructions stored therein. Said means configured to determine the equation of the straight line and the shortest distance may comprise the processor being configured to access the memory device and execute the instructions stored therein such that it is operable to determine said straight line and shortest distance in dependence on the vehicle data, so as to determine in real time whether to permanently store the temporary data point as a permanent data point.

In addition the electronic controller, or the one or more controller, may have an internal or associated external, memory means, for example a solid state memory device. It will be appreciated that all the functional “means” referred to throughout this document may be considered as control functions within one or more electronic control units or controllers. Other types of processor means are envisaged, other than electronic, and the inputs need not be electrical.

The at least one vehicle-related feature may include at least one of geographical location of the vehicle, or a direct feature of the vehicle itself. For example, the at least one vehicle-related feature may include vehicle roll, vehicle speed, roughness of the surface over which the vehicle is travelling, vehicle pitch, vehicle yaw and vehicle altitude. Other vehicle-related features may be included in addition, or alternatively, to these. By vehicle-related feature is meant any feature (capable of measurement) relating to the vehicle or its surroundings. This means that data relating to a wide variety of aspects of a vehicle journey may be stored by the system. The at least one subsystem of the vehicle may include at least one of a navigation subsystem, a vehicle roll sensor, a vehicle speed sensor, a surface roughness sensor, a vehicle pitch sensor, a vehicle yaw sensor and a vehicle altitude sensor.

In an embodiment, the first location is substantially the location of the vehicle at the start of the vehicle journey. The second location may satisfy a predetermined condition relative to the first location and/or the vehicle. The predetermined condition may be that the second location is a predetermined distance from the first location. Alternatively, or in addition, the predetermined condition may be that the second location is a predetermined vehicle journey time from the first location. Further, the predetermined condition may be that a vehicle event occurs at the second location. Storing a temporary data point when a vehicle event occurs ensures that changes in, for example, the direction and/or speed of travel, or surface conditions that occur over a reasonably short time period are captured by the system. Such vehicle events may include a vehicle slip event and/or the vehicle arriving at a junction.

In an embodiment, the temporary data point is discarded if the calculated shortest distance is less than the predetermined threshold distance value. This means that data points which are not deemed necessary in order to store to the required accuracy the evolution of the at least one vehicle-related feature are discarded, hence saving memory space. It may be the case that any collected temporary data points are temporarily stored until one is permanently stored as a permanent data point. In this case it may also be that when a temporary data point is stored as a permanent data point then only temporary data points collected prior to the collection of the permanent data point are discarded. The predetermined threshold value may be a constant value.

Each data point may be of at least two dimensions. The system may comprise means configured to approximate a route travelled by the vehicle during the vehicle journey on the basis of permanently stored permanent data points. The means configured to approximate the route may be configured to join the permanently stored permanent data points with straight lines. Alternatively, the means configured to approximate the route may be configured to use a curve fitting technique to fit a curve to the permanently stored permanent data points. The shortest distance between the temporary data point and the determined straight line may be the Euclidean distance.

According to another aspect of the present invention there is provided a method for use in a vehicle for determining in real time whether to permanently store vehicle data indicative of at least one vehicle-related feature during a vehicle journey, the method comprising receiving the vehicle data from at least one subsystem of the vehicle and permanently storing the vehicle data indicative of the at least one vehicle-related feature at a first location of the vehicle journey as a permanent data point. The method also includes temporarily storing the vehicle data indicative of the at least one vehicle-related feature at a second location of the vehicle journey as a temporary data point, the second location being subsequent to the first location, and determining an equation of the straight line passing through the permanent data point and a current data point indicative of the at least one vehicle-related feature at substantially a current location of the vehicle. Further, the method includes determining a shortest distance between the temporary data point and the determined straight line. The temporary data point is permanently stored as a permanent data point only if the calculated shortest distance is greater than a predetermined threshold distance value.

This method may be repeated for a plurality of temporary data points and the straight line may be determined using the most recently stored permanent data point. The method advantageously is performed as and when temporary data points are stored during the vehicle journey. This could reduce the memory requirements of the vehicle because data points that do not need to be permanently stored may be discarded or overwritten by subsequent data points relatively quickly. One or more temporary data points may be temporarily stored before the above method is performed. If more than one temporary data point meets the criteria that the calculated shortest distance is greater than the predetermined threshold distance value, then it may be the case that only the temporary data point farthest from the straight line is permanently stored as a permanent data point.

A temporary data point may be automatically permanently stored as a permanent data point if the time and/or the distance travelled by the vehicle since the previous permanent data point was permanently stored is greater than a prescribed threshold value. This ensures that there are not large gaps (in terms of distance and/or time) between permanent data points stored in memory, which would reduce the accuracy of the approximated route.

In an embodiment, it may be determined whether to permanently store a first temporary data point as a permanent data point substantially simultaneously with a second temporary data point being temporarily stored. A plurality of temporary data points may be temporarily stored before it is determined whether to permanently store one or more of the temporary data points as permanent data points.

The temporary data points may be stored at a frequency greater than or substantially equal to 1 Hertz. For example, the temporary data points may be stored at a frequency of substantially 20 Hertz.

According to a further aspect of the present invention, there is provided a non-transitory, computer-readable storage medium storing instructions thereon that when executed by one or more electronic processors causes the one or more electronic processors to carry out any of the methods described above.

According to a still further aspect of the present invention there is provided a vehicle comprising any of the systems described above.

Although the above invention is described in relation to being used on a vehicle, the above system and method may be used in other applications. For example, the system and method may be used by hikers to track a path covered when walking up a hill or mountain.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying figures, in which:

FIG. 1 is a schematic overview of a vehicle provided with a vehicle control system (VCS) according to an embodiment of the present invention;

FIG. 2 is a schematic diagram of the VCS in FIG. 1;

FIGS. 3a, 3b and 3c are schematic diagrams illustrating a route undertaken by the vehicle at different times, and stored by the VCS, in FIG. 1; and

FIG. 4 is a flow diagram illustrating the steps of a method carried out by the VCS in FIG. 2 for storing the route undertaken by the vehicle in FIG. 3.

### DETAILED DESCRIPTION

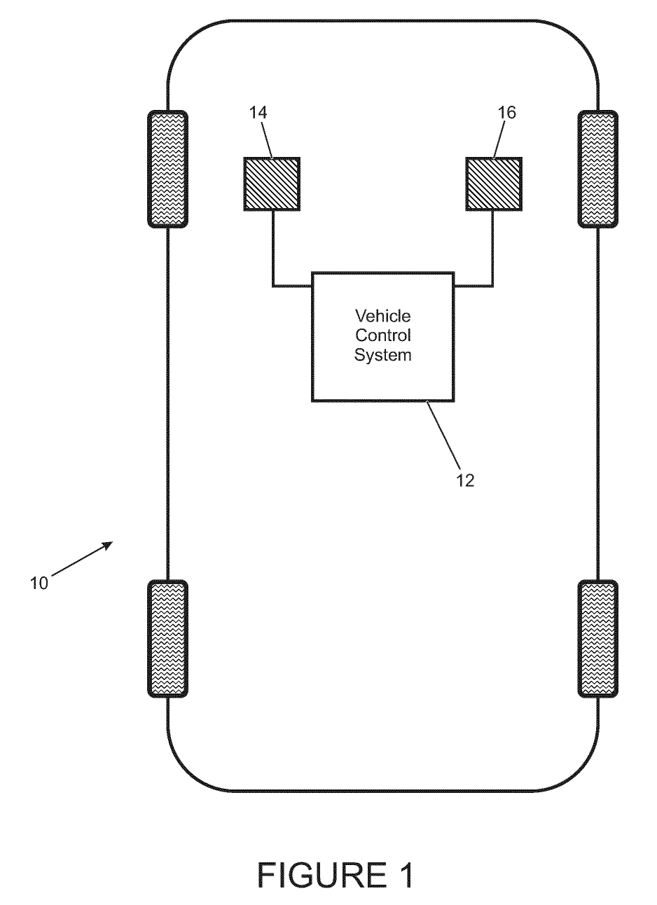

FIG. 1 shows one embodiment of a vehicle 10 including a vehicle control system (VCS) 12 for carrying out a method according to an aspect of the present invention. In particular, the VCS 12 is configured to store in real time a route travelled by the vehicle 10. The vehicle 10 also includes a navigation subsystem 14 such as a Global Positioning System (GPS) for measuring positional data relating to the location of the vehicle 10, and a human machine interface (HMI) 16 for communicating the route travelled by the vehicle 10 to the driver.

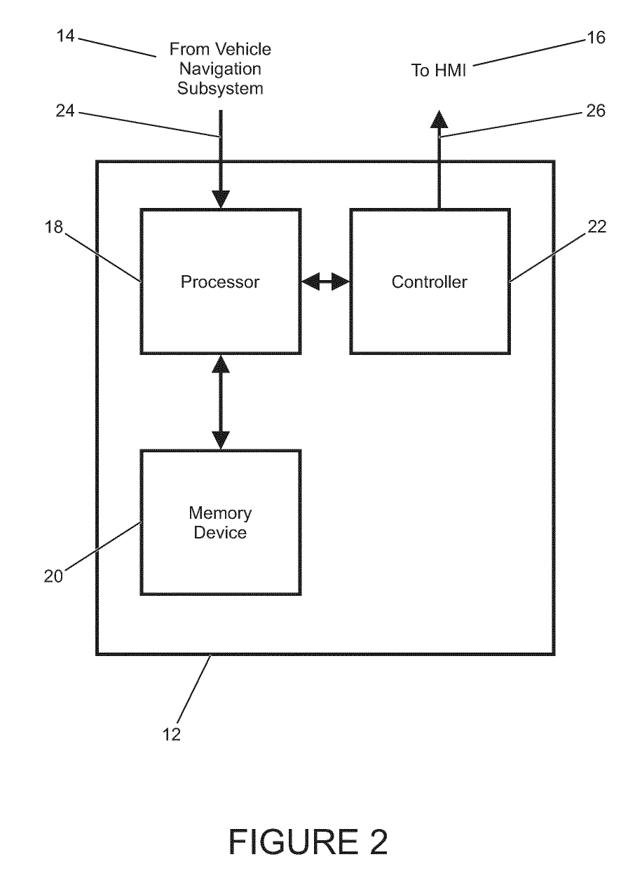

With reference to FIG. 2, the VCS 12 includes a processor 18, a memory device 20, and a controller 22. The processor 18 includes an input 24 for receiving positional data from the navigation subsystem 14 (i.e. the geographical location of the vehicle 10). The positional data is referred to as a vehicle-related feature. In different embodiments, the processor 18 may receive data relating to vehicle-related features of the current state of the vehicle 10 from sensors or subsystems other than, or in addition to, the navigation subsystem 14. For example, data that is input into the processor 18 may include, but is not restricted to, the vehicle-related features: vehicle roll, vehicle speed, surface roughness, vehicle pitch, vehicle yaw and vehicle altitude. In this respect, the VCS 12 may be configured to store vehicle-related features of a route undertaken by the vehicle 10 other than positional data, such as vehicle roll, vehicle speed, surface roughness, vehicle pitch, vehicle yaw and vehicle altitude. Vehicle-related features may also be referred to as a vehicle-related parameters or vehicle-related variables. The controller 22 has an output 26 for communicating with the HMI 16.

The present embodiment describes a case in which the positional data is received and stored in two dimensions as a data point; however, this may readily be extended to three dimensions. Also, the data point may include different types of data, for example positional and spectral data, and so the described system and method may be extended to n-dimensional data points.

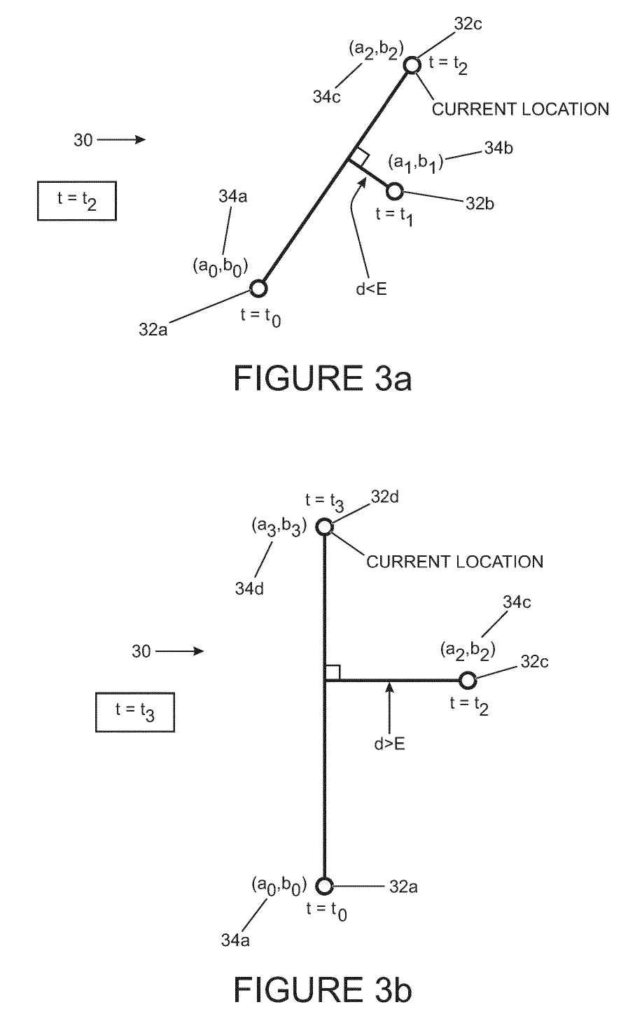

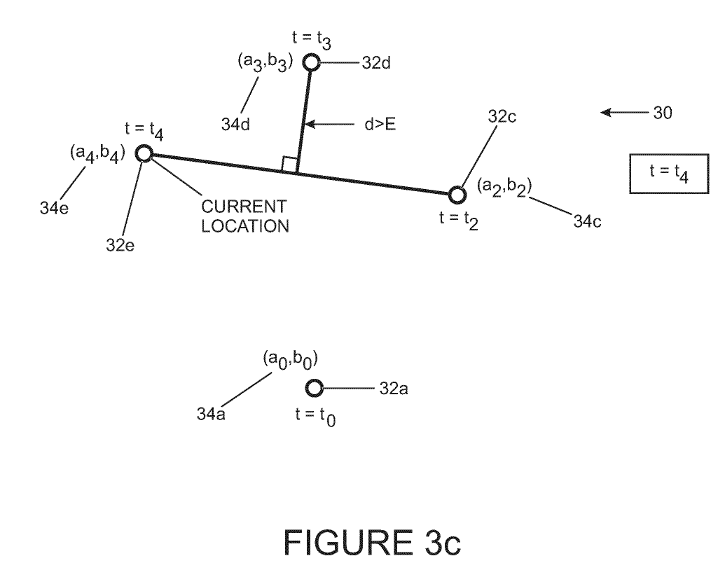

FIGS. 3a, 3b and 3c illustrate part of a route 30 undertaken by the vehicle 10. Positional data relating to the location of the vehicle 10 is measured by the navigation subsystem 14 as the vehicle travels along the route 30. The measured positional data is communicated to the VCS 12 at different locations along the route 30 in real time. Here and throughout, the term ‘real time’ is taken to mean that the process is carried out in the order of seconds. In this case that means the positional data relating to the location of the vehicle 10 is communicated to the VCS 12 during a journey of the vehicle 10. FIGS. 3a, 3b and 3c show the locations at which the navigation subsystem 14 communicates the location of the vehicle 10 to the VCS 12, namely at locations 32a, 32b, 32c, 32d, 32e at times t=t₀, t₁, t₂, t₃, t₄. In this example, the location 32a represents the location at which the vehicle journey started, that is, time t=t₀ represents the start time of the vehicle journey. In FIGS. 3a, 3b and 3c the current locations of the vehicle 10 are locations 32c, 32d and 32e, respectively (i.e. times t=t₂, t₃, t₄).

The positional data is in the form of a data point including longitudinal and latitudinal coordinates; however, the positional data may be any suitable means of recording the location of the vehicle. The term ‘data point’ may be taken to mean a coordinate point, a vector, or any other suitable structure for recording positional data. If the positional data that is input into the processor 18 is not in the form of a data point, then the processor 18 may convert the positional data to a data point. The coordinates of the data points at times t=t₀, t₁, t₂, t₃, . . . , tₙ are denoted by (x, y)=(a₀, b₀), (a₁, b₁), (a₂, b₂), (a₃, b₃), . . . , (aₙ, bₙ), where x and y denotes the longitudinal and latitudinal directions, respectively.

With reference to FIGS. 2 and 3, at time t=t₀ the navigation subsystem 14 measures positional data relating to the location 32a of the vehicle 10, and inputs this positional data in the form of a data point 34a to the processor 18 via the input 24. This initial or first data point 34a is then permanently stored in the memory device 20 as a so-called permanent data point. A permanent data point is a data point that is stored permanently by the VCS 12 (in the memory device 20) and which is to be used to determine a route undertaken by the vehicle 10, as is described in detail below. The first location at which positional data is communicated from the navigation subsystem 14 to the VCS 12 (in this case the data point 34a at location 32a) is always permanently stored as a permanent data point. Each of the other locations at which positional data is communicated from the navigation subsystem 14 to the VCS 12 is initially temporarily stored in the VCS 12 as a so-called temporary data point. Each temporary data point will subsequently either be permanently stored in the memory device 20 as a permanent data point or will be simply discarded by the VCS 12, as will be described in greater detail below.

A temporary data point may be input into the processor 18 and temporarily stored in the memory device 20 under a variety of conditions. For example, temporary data points may be temporarily stored at predetermined intervals of distance and/or time. In addition, a temporary data point may be temporarily stored in the case of a vehicle event such as vehicle slip, a change in the type of terrain over which the vehicle is travelling, and/or a gear change. In general, temporary data points are input and stored relatively frequently so that any relatively sudden changes in direction will be captured and permanently stored as permanent data points for use in approximating the route as is described below. This frequent input and storage of temporary data points is possible because each temporary data point is analysed (i.e. permanently stored or discarded) in real time, and so there is no need for a large amount of memory to store all of the temporary data points, as in the prior art. For example, temporary data points may be recorded at the maximum rate of a GPS, namely substantially 20 Hertz.

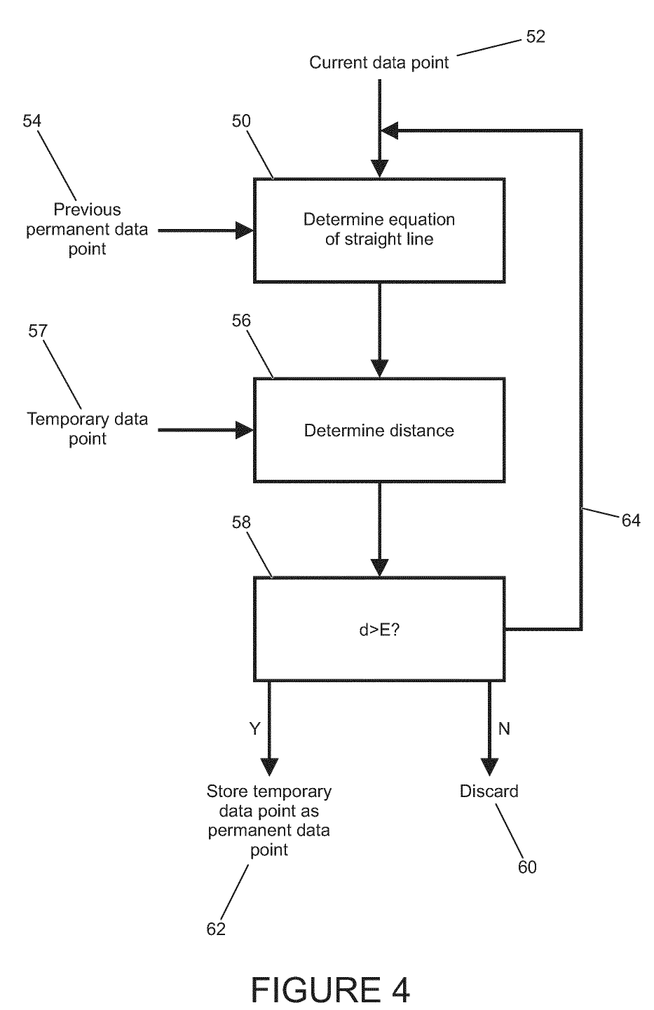

As such, at time t=t₁ the data point 32b relating to the location 34b of the vehicle 10 is input into the processor 18 via the input 24 and temporarily stored as a temporary data point. FIG. 4 illustrates the steps of a method for determining in real time whether to permanently store temporary data points that will subsequently be used to approximate the route 30 travelled by the vehicle 10, the method being carried out by the VCS 12. In summary, at step 50 the processor 18 determines the equation of the straight line passing through the current location 52 of the vehicle 10 and the location of the previous (most recent) permanent data point 54. Initially the previous permanent data point is the location 32a at which the route 30 started. At step 56, the processor 18 determines the shortest distance between a temporary data point 57 (that is located between the current location 52 of the vehicle 10 and the previous permanent data point 54) and the determined straight line equation. At step 58 the processor 18 compares the determined distance d with a predetermined threshold error value E. If d<E then the temporary data point is discarded by the VCS 12 at step 60 (thus freeing up storage space). This means that the data point is not permanently stored for use in approximating the route 30 travelled by the vehicle 10. The term “discarded” may be taken to mean that the data point is available to be overwritten. If on the other hand d>E then the temporary data point is permanently stored as a permanent data point in the memory device 20 at step 62, to be used to approximate the route 30 travelled by the vehicle 10. The process then loops back to the start at step 64 to analyse the next current data point 52.

For example, at time t=t₂ (i.e. as shown in FIG. 3a) the data point 34c relating to the current location 32c of the vehicle 10 (as measured by the navigation subsystem 14) is input into the processor 18 via the input 24. The processor 18 also retrieves the data point 34a relating to the initial location 32a at t=t₀ from the memory device 20, and at step 50 determines the equation of the straight line between the data points 34a and 34c.

The equation of the straight line between the data points 34a and 34c is given by:

(b₂−b₀)x+(a₀−a₂)y+a₂b₀−a₀b₂=0,

which, for simplicity, may be written as:

Ax+By+C=0, (1)

where

A=b₂−b₀,

B=a₀−a₂,

and

C=a₂b₀−a₀b₂.

Note that the equation of a straight line may be written in many different, but equivalent, ways, as is well known in the art. At step 56, the processor 18 determines the shortest distance between the temporary data point 34b denoted by (a₁, b₁) and the determined straight line equation (1).

It is known that the shortest distance from a point to a straight line is given by the length of the line segment which joins the point to the straight line at right angles. The shortest distance d between point (a₁, b₁) and the equation Ax+By+C=0 is therefore given by:

$$d = \frac{\vert {Aa}_{1} + {Bb}_{1} + C \vert}{\sqrt{{A}^{2} + {B}^{2}}} . \qquad ( 2 )$$

At step 58 the processor 18 compares the determined distance d with the predetermined threshold error value E. It may be seen from FIG. 3a that in this case d<E and so the short term data point 34b is discarded.

The flow diagram shown in FIG. 4 then loops back at 64, and the process is repeated at the location 32d for the next temporary data point 34c (i.e. at time t=t₃, as shown in FIG. 3b). The previous permanent data point (i.e. the permanent data point most recently permanently stored in the memory device 20) is still the initial data point 34a. Therefore at step 50 the processor 18 determines the equation of the straight line between the data points 34a and 34d, which is given by equation (1) with a₂ and b₂ being replaced by a₃ and b₃, respectively, in the expressions for A, B, C above. Similarly to above, the processor 18 determines the shortest distance between the new temporary data point 34c denoted by (a₂, b₂) and the new determined straight line. Specifically, this is given by the expression in equation (2) with a₂ and b₂ replacing a₁ and b₁, respectively.

At step 58 the processor 18 compares the determined distance d with the predetermined threshold error value E. It may be seen from FIG. 3b that in this case d>E and so the short term data point 34c is permanently stored in the memory device 20 as a permanent data point.

The method again loops back at 64, and the process is repeated at the location 32e for the next temporary data point 34d (i.e. at time t=t₄, as shown in FIG. 3c). The previous permanent data point is now the data point 34c. Therefore at step 50 the processor 18 determines the equation of the straight line between the data points 34c and 34e (i.e. between the current location and the previous permanent data point), which is given by equation (1) with a₀, a₂, b₀ and b₂ being replaced by a₂, a₄, b₂ and b₄, respectively, in the expressions for A, B, C above. The shortest distance between the new temporary data point 34d denoted by (a₃, b₃) and the new determined straight line is given by equation (2) with a₃ and b₃ replacing a₁ and b₁, respectively. It is illustrated in FIG. 3c that in this case d>E and so the short term data point 34c is also permanently stored in the memory device 20 as a permanent data point.

This process continues for the duration of the journey. The VCS 12 may be configured such that if a prescribed period of time passes, or a prescribed distance is travelled, without a temporary data point being permanently stored as a permanent data point then the next temporary data point is automatically permanently stored as a permanent data point, in order to maintain the accuracy of the approximated route.

In the embodiment described above, the location at which the VCS 12 determines whether to permanently store or to discard a temporary data point coincides with the time at which a new temporary data point is received from the navigation subsystem 14 (i.e. at times t=t₂, t₃, t₄,). In different embodiments, this need not be the case.

The present embodiment describes a system in which a single temporary data point is temporarily stored in the VCS 12 before it is either temporarily stored as a permanent data point or discarded. However, this may be adapted so that a plurality of temporary data points is communicated to the VCS 12 before deciding whether one or more of the plurality is temporarily stored as a permanent data point or discarded.

At the end of a journey, or at any point subsequent to this, the stored permanent data points are used to approximate the route travelled by the vehicle 10 in any suitable way. For example, the route may be approximated by joining the permanent data points with straight lines. Alternatively, a curve-fitting technique may be used to fit a curve to the permanent data points. The permanent data points may also be used without any further post processing as the approximated route. The controller 22 may then communicate the approximated route to the driver via the HMI 16.

The above-described embodiment determines the Euclidean distance between a point and a straight line; however, any other suitable distance metric may be used.

In the description and claims, the term “permanently stored data point” may be taken to mean that the data point is stored at least until the end of a vehicle journey. Such a data point may be discarded or overwritten automatically, or by a driver, subsequent to this.

Note that the VCS 12 may be required to analyse one or more temporary data points once a vehicle journey has ended, and so the vehicle journey end point is considered to be part of the vehicle journey in the description and claims.

1. A system for use in a vehicle for determining in real time whether to permanently store vehicle data indicative of at least one vehicle-related feature during a vehicle journey, the at least one vehicle-related feature including at least one feature other than geographical location of the vehicle, the system comprising:
an electrical input configured to receive the vehicle data from at least one subsystem of the vehicle;
an electronic memory device configured to permanently store the vehicle data indicative of the at least one vehicle-related feature at a first location of the vehicle journey as a permanent data point, and further configured to temporarily store the vehicle data indicative of the at least one vehicle-related feature at a second location of the vehicle journey as a temporary data point, the second location being subsequent to the first location; and
an electronic processor operable during the vehicle journey to determine an equation of a straight line passing through the permanent data point and a current data point indicative of the at least one vehicle-related feature at substantially a current location of the vehicle, to determine a shortest distance between the temporary data point and the straight line, and to approximate a route travelled by the vehicle during the vehicle journey on the basis of the permanently stored permanent data point,
wherein the electronic processor is configured to cause the temporary data point to be stored in the electronic memory device as a permanent data point only if the determined shortest distance is greater than a predetermined threshold distance value.

2. (canceled)

3. The system according to claim 1, wherein the at least one vehicle-related feature includes at least one of vehicle roll, vehicle speed, surface roughness, vehicle pitch, vehicle yaw and vehicle altitude.

4. The system according to claim 1, wherein the at least one subsystem of the vehicle includes at least one of a navigation subsystem, a vehicle roll sensor, a vehicle speed sensor, a surface roughness sensor, a vehicle pitch sensor, a vehicle yaw sensor and a vehicle altitude sensor.

5. The system according to claim 1, wherein the first location is substantially a location of the vehicle at a start of the vehicle journey.

6. The system according to claim 1, wherein the second location satisfies a predetermined condition relative to the first location and/or the vehicle.

7. The system according to claim 6, wherein the predetermined condition is one or more of: the second location being a predetermined distance from the first location, the second location being a predetermined vehicle journey time from the first location, and a vehicle event occurring at the second location.

8-10. (canceled)

11. The system according to claim 1, wherein the temporary data point is discarded if the determined shortest distance is less than the predetermined threshold distance value.

12. The system according to claim 1, wherein the predetermined threshold value is a constant value.

13-14. (canceled)

15. The system according to claim 1, wherein the electronic processor is configured to join permanently stored permanent data points with straight lines.

16. The system according to claim 1, wherein the electronic processor is configured to use a curve fitting technique to fit a curve to the permanently stored permanent data points.

17. (canceled)

18. A method for use in a vehicle for determining in real time whether to permanently store vehicle data indicative of at least one vehicle-related feature during a vehicle journey, the at least one vehicle-related feature including at least one feature other than geographical location of the vehicle, the method comprising:
receiving the vehicle data from at least one subsystem of the vehicle;
permanently storing the vehicle data indicative of the at least one vehicle-related feature at a first location of the vehicle journey as a permanent data point;
temporarily storing the vehicle data indicative of the at least one vehicle-related feature at a second location of the vehicle journey as a temporary data point, the second location being subsequent to the first location; and
determining an equation of a straight line passing through the permanent data point and a current data point indicative of the at least one vehicle-related feature at substantially a current location of the vehicle, and determining a shortest distance between the temporary data point and the straight line; and
approximating a route travelled by the vehicle on the basis of the permanently stored permanent data point,
wherein the temporary data point is permanently stored as a permanent data point only if the determined shortest distance is greater than a predetermined threshold distance value.

19. The method according to claim 18, wherein the method is repeated for a plurality of temporary data points and the equation of the straight line is determined using a most recently stored permanent data point.

20. The method according to claim 19, wherein a temporary data point is automatically permanently stored as a permanent data point if the time and/or the distance travelled by the vehicle since a previous permanent data point was permanently stored is greater than a prescribed threshold value.

21. The method according to claim 19, wherein it is determined whether to permanently store a first temporary data point as a permanent data point substantially simultaneously as a second temporary data point is temporarily stored.

22. The method according to claim 19, wherein a plurality of temporary data points are temporarily stored before it is determined whether to permanently store one or more of the plurality of temporary data points as permanent data points.

23. The method according to claim 19, wherein temporary data points are stored at a frequency greater than or substantially equal to 1 Hertz.

24. The method according to claim 23, wherein the temporary data points are stored at a frequency of substantially 20 Hertz.

25. A non-transitory, computer-readable storage medium storing instructions thereon that when executed by one or more electronic processors causes the one or more electronic processors to carry out the method of claim 18.

26. A vehicle comprising the system according to claim 1.

27. (canceled)
